(19) United States
(12) Patent Application Publication
(10) Pub. No.: US 2026/0124792 A1
(43) Pub. Date: May 7, 2026

(54) CLEANING AGENT COMPOSITION, CLEANING MATERIAL, AND METHOD OF CLEANING MOLD FOR MOLDING

(71) Applicant: RESONAC CORPORATION, Tokyo (JP)

(72) Inventors: Kensaku UNOKI, Kanzaki-gun, Saga (JP); Koichi TAKASHIMA, Kanzaki-gun, Saga (JP); Takaaki UEHARA, Kanzaki-gun, Saga (JP)

(73) Assignee: RESONAC CORPORATION, Tokyo (JP)

(21) Appl. No.: 18/861,590

(22) PCT Filed: Jun. 12, 2024
(86) PCT No.: PCT/JP2024/021422

§ 371 Date: Oct. 30, 2024

(30) Foreign Application Priority Data
Jul. 26, 2023 (WO) PCT/JP2023/027450

(51) Int. Cl. B29C 33/72; B08B 7/00; B08B 7/04; C11D 3/30

(52) U.S. Cl. CPC B29C 33/722; B08B 7/0014; B08B 7/0071; B08B 7/04; C11D 3/30; B08B 2220/04

(57) ABSTRACT

A cleaning agent composition contains a main material for the cleaning agent composition; and an amine compound which does not include an amino group located at an end of a molecular chain but includes an amino group located at a position other than the end of the molecular chain.

### TECHNICAL FIELD

The disclosure relates to a cleaning agent composition, a cleaning material, and a method of cleaning mold for molding.

### RELATED ART

In the field of plastic molding, such as injection molding, transfer molding, and compression molding, molding using a mold is typically repeated. As the number of molding cycles increases, molding materials or components derived from them accumulate inside the mold, causing mold contamination. Such mold contamination may reduce the mold release properties of molded products and may cause appearance defects. Furthermore, if the contamination continues to accumulate, it may lead to dimensional abnormalities in the molded products.

Therefore, to prevent adverse effects caused by contaminated molds, the mold needs to be cleaned periodically, and contaminants adhering to the mold surface need to be removed from the mold surface.

As a mold cleaning agent composition that exhibits excellent cleaning effects on molds contaminated by repeated molding operations, a mold cleaning agent composition containing at least one of synthetic rubber and synthetic resin as a base material, at least one of an alkali metal salt and an alkali metal hydroxide, and an organic solvent or water is known (for example, refer to Patent Documents 1 and 2). A mold cleaning material consisting of such a mold cleaning agent composition is placed in an open mold, then the mold is closed, and heat and pressure are applied with the mold cleaning material sandwiched inside. This allows the contaminants formed on the surface of the mold to be integrated into the mold cleaning material, and the mold surface can be cleaned by peeling off the mold cleaning material with the integrated contaminants from the mold.

### PRIOR-ART DOCUMENT

### Patent Document

Patent Document 1: Japanese Patent Laid-Open No. 2011-021156
Patent Document 2: Japanese Patent Laid-Open No. 2011-020416

### SUMMARY OF INVENTION

### Problems to be Solved by the Invention

In addition to the mold cleaning methods described in Japanese Patent Application Laid-Open Publication No. 1 and 2, there is also a method of cleaning the mold by removing contaminants adhering to the mold surface using a molded mold cleaning material formed by molding a mold cleaning agent composition containing amine-based compounds. However, although the cleaning agent composition containing an amine-based compound has an excellent cleaning effect on the inside of a mold, when the mold is repeatedly cleaned using the cleaning agent composition, contamination may occur on the outer periphery of the mold.

The disclosure aims to provide a cleaning composition capable of suppressing contamination of the outer periphery of a mold for molding, a cleaning material formed by molding the composition, and a method of cleaning mold for molding that cleans a mold for molding using the cleaning agent composition.

### Means for Solving the Problems

The means for solving the aforementioned problems include the following aspects.
<1> A cleaning agent composition, including:
a main component of the cleaning agent composition; and
an amine compound which does not include an amino group located at an end of a molecular chain but includes an amino group located at a position other than the end of the molecular chain.
<2> A cleaning agent composition, including:
a reinforcing material of the cleaning agent composition; and
an amine compound which does not include an amino group located at an end of a molecular chain end but includes an amino group located at a position other than the end of the molecular chain.
<3> A cleaning agent composition, including an amine compound which does not include an amino group located at an end of a molecular chain but includes an amino group located at a position other than the end of the molecular chain and used for cleaning a mold for molding of thermosetting resin.
<4> The cleaning agent composition according to any one of <1> to <3>, in which the amine compound includes at least one compound selected from a group consisting of a secondary amine compound and a tertiary amine compound.
<5> The cleaning agent composition according to <4>, in which
the amine compound contains the secondary amine compound, and
the secondary amine compound is at least one selected from a group consisting of methylethanolamine, ethylethanolamine, propylethanolamine, butylethanolamine, dimethylamine, diisopropanolamine, and diethanolamine.
<6> The cleaning agent composition according to any one of <1> to <3>, in which the amine compound contains only one hydroxyl group.
<7> The cleaning agent composition according to in any one of <1> to <6>, in which a content of the amine compound with respect to 100 parts by mass of the main material is less than 20 parts by mass.
<8> A cleaning material formed by molding the cleaning agent composition according to in any one of <1> to <7>.
<9> A method of cleaning mold for molding, including:
a step of placing the cleaning material according to in <8> inside an opened mold for molding;
a step of sandwiching the cleaning material using the mold for molding by closing the mold for molding, and applying heat and pressure, and
a step of peeling off the cleaning material from the mold for molding.

### Effects of Invention

According to the disclosure, a cleaning agent composition capable of suppressing contamination of the outer periphery of a mold for molding, a cleaning material formed by molding the composition, and a method of cleaning mold for molding that cleans the mold for molding using the cleaning agent composition.

### DESCRIPTION OF THE EMBODIMENTS

The following describes in detail the embodiments for implementing the disclosure. However, the embodiments of the disclosure are not limited to the following embodiments. In the following embodiments, the components (including elements, steps, etc.) are not essential unless specifically stated. The same applies to numerical values and their ranges, which do not limit the embodiments of the disclosure.

In the disclosure, the term “step” includes not only steps independent from other steps, but also steps that cannot be clearly distinguished from other steps, as long as the purpose of that step is achieved.

In the disclosure, a numerical range indicated using “˜” includes the values before and after “˜” as the minimum and maximum values, respectively.

In the numerical ranges described stepwise in the disclosure, an upper limit or lower limit value described in one numerical range may be replaced with an upper limit or lower limit value of another stepwise described numerical range. Moreover, in the numerical ranges described in the disclosure, the upper limit or lower limit value of that numerical range may be replaced with a value shown in the Examples.

In the disclosure, each component may contain multiple types of corresponding substances. In the case where multiple types of substances corresponding to each component are present in the composition, the content rate or content of each component means the total content rate or content of the multiple types of substances present in the composition, unless otherwise specified.

### [Cleaning Agent Composition]

### First Embodiment

A cleaning agent composition according to the first embodiment of the disclosure contains a main material of the cleaning gent composition; and an amine compound which does not include an amino group located at an end of a molecular chain but includes an amino group located at a position other than the end of the molecular chain (hereinafter also referred to as a “specific amine compound”).

By the cleaning agent composition of the first embodiment including the specific amine compound, even in the case of repeatedly cleaning the mold using the cleaning agent composition, contamination of the outer periphery of the mold can be suppressed. The reason for this is presumed to be as follows. However, the disclosure is not limited to the following speculation.

In the case of using a cleaning agent composition containing an amine compound that includes an amino group located at an end of a molecular chain (hereinafter also referred to as a “end amino group-containing compound”) for cleaning a mold, the end amino group-containing compound is prone to degradation, deterioration, etc. when the cleaning material formed by molding the cleaning agent composition is heated. As a result, by repeatedly cleaning the mold using the cleaning agent composition containing the end amino group-containing compound, contaminants tend to accumulate on the outer periphery of the mold.

On the other hand, with the cleaning agent composition of the disclosure, when heating the cleaning material formed by molding the cleaning agent composition, deterioration, degradation, etc. of the specific amine compound is less likely to occur. As a result, even in the case of repeatedly cleaning the mold using the cleaning agent composition, contamination of the outer periphery of the mold can be suppressed.

The cleaning agent composition is preferably used for cleaning a thermosetting resin mold for molding.

### (Main Material)

The cleaning agent composition includes a main material. Examples of the main material include rubber materials and resin materials.

The main material may be used alone as a single type or in combination of two or more types.

Examples of rubber materials include butadiene rubber such as 1,2-polybutadiene, 1,4-polybutadiene, and mixtures thereof; nitrile rubber; ethylene-α-olefin rubber such as ethylene-propylene rubber; ethylene-α-olefin-polyene rubber; styrene-butadiene rubber; polyisoprene rubber; butyl rubber; silicone rubber; and fluorine rubber.

The rubber material may be used alone as a single type or in combination of two or more types. For example, a mixture of butadiene rubber and ethylene-α-olefin rubber such as ethylene-propylene rubber may be used.

Examples of resin materials include polyamide resins such as nylon 6 and nylon 66; polyester resins such as polyethylene terephthalate and polybutylene terephthalate; polycarbonate resins; polyarylate resins; vinyl chloride resins; chlorinated vinyl chloride resins; polyethylene resins; chlorinated polyethylene resins; chlorinated polypropylene resins; polypropylene resins; polystyrene resins; acrylonitrile-styrene resins; vinylidene chloride resins; vinyl acetate resins; polyacrylate resins; polyimide resins; butadiene resins; polyacetal resins; ionomer resins; ethylene-vinyl chloride copolymer resins; ethylene-vinyl acetate copolymer resins; ethylene-vinyl acetate-vinyl chloride graft copolymer resins; polyphenylene resins; polysulfone resins; methacrylate resins; acrylic-fluorine resins; acrylic-silicone oligomers; silicone resins; epoxy-containing silicone-acrylic resins; vinyl ester resins; furan resins; phenolic resins; melamine resins; guanamine resins; urea resins; polyurethane resins; diacryl phthalate resins; ketone resins; epoxy resins; xylene resins; maleic resins; phenoxy resins; coumarone resins; polyvinyl formal resins; polyvinyl butyral resins; and like.

The resin material may be used alone as a single type or in combination of two or more types.

As will be described later, the main material such as rubber material or resin material may be used in combination with a crosslinking agent, curing agent, etc. As a result, when the cleaning material formed by molding the cleaning agent composition is heated, the cleaning material becomes in a cured state, and the cleaning material in the cured state may be extracted from the mold. Examples of methods for curing the cleaning material include curing by heating, curing by cooling thermoplastic resins, etc., and it is preferable to use a crosslinking agent, curing agent, etc. for curing by heating.

The content rate of the main material with respect to the total amount of the cleaning agent composition may be 40 mass %˜95 mass %, may be 50 mass %˜90 mass %, or may be 50 mass %˜70 mass %.

### (Specific Amine Compound)

The cleaning agent composition contains an amine compound (specific amine compound) which does not include an amino group located at an end of the molecular chain and includes an amino group located at a position other than the end of the molecular chain.

The specific amine compound may be used alone as a single type or in combination of two or more types.

The specific amine compound preferably contains at least one compound selected from the group consisting of secondary amine compounds and tertiary amine compounds, and more preferably contains a secondary amine compound.

The specific amine compound (preferably, at least one compound selected from the group consisting of secondary amine compounds and tertiary amine compounds) may be a compound containing a hydroxyl group or may be a compound not containing a hydroxyl group. In the case where the specific amine compound is a compound containing a hydroxyl group, the specific amine compound may contain only one hydroxyl group or may contain two or more hydroxyl groups. From the viewpoint of more suitably suppressing contamination of the outer periphery of the mold, it is preferable that the specific amine compound contains only one hydroxyl group.

Examples of the specific amine compound include methylethanolamine, ethylethanolamine, propylethanolamine, butylethanolamine, octyldiethanolamine, triethanolamine, dimethylamine, dimethylcyclohexylamine, dimethylhexylamine, cyclohexylamine, diisobutylamine, di-n-butylamine, diisopropanolamine, diethanolamine, etc. Among these, from the viewpoint of mold cleaning performance, methylethanolamine, ethylethanolamine, propylethanolamine, butylethanolamine, dimethylamine, diisopropanolamine and diethanolamine are preferable, and from the viewpoint of more suitably suppressing contamination of the outer periphery of the mold, methylethanolamine, ethylethanolamine, propylethanolamine, butylethanolamine and dimethylamine are preferable.

The content rate of the specific amine compound with respect to the total amount of the cleaning agent composition may be 1 mass %˜20 mass %, may be 2 mass %˜15 mass %, or may be 3 mass %˜10 mass %.

The content of the amine compound with respect to 100 parts by mass of the main material may be 30 parts by mass or less. From the viewpoint of suppressing the phenomenon (blooming phenomenon) in which components such as the specific amine compound contained in the cleaning agent composition seep out to the surface, it is preferable to be less than 20 parts by mass, more preferable to be 18 parts by mass or less, and even more preferable to be 16 parts by mass or less.

The content of the amine compound with respect to 100 parts by mass of the main material may be 1 part by mass or more, may be 3 parts by mass or more, or may be 5 parts by mass or more.

### (Crosslinking Agent)

The cleaning agent composition may contain a crosslinking agent, and may contain a crosslinking agent, for example, in the case where rubber material, polyethylene resin, etc are included as the main material. As the crosslinking agent, there is no particular limitation as long as it may crosslink the rubber material, and for example, organic peroxide may be mentioned.

The crosslinking agent may be used alone or in combination of two or more types.

As the organic peroxide, for example, 1,1-bis(t-butylperoxy)-3,3,5-trimethylcyclohexane, 1,1-bis(t-butylperoxy)cyclohexane, t-butylperoxy maleic acid, t-butylperoxy oleate, t-butylperoxy-3,3,5-trimethylhexanoate, cyclohexanone peroxide, t-butylperoxy aryl carbonate, t-butylperoxy isopropyl carbonate, 2,5-dimethyl-2,5-di(benzoylperoxy)hexane, 2,2-bis(t-butylperoxy)octane, t-butylperoxy acetate, 2,2-bis(t-butylperoxy)butane, t-butylperoxy benzoate, n-butyl-4,4-bis(t-butylperoxy)valerate, di-t-butylperoxy isophthalate, methyl ethyl ketone peroxide, dicumyl peroxide, 2,5-dimethyl-2,5-di(t-butylperoxy)hexane, α,α′-bis(t-butylperoxy-m-isopropyl)benzene, t-butylcumyl peroxide, diisopropylbenzene hydroperoxide, di-t-butyl peroxide and 2,5-dimethyl-2,5-di(t-butylperoxy)hexane-3 may be mentioned.

In the case where the cleaning agent composition contains a crosslinking agent, the content rate of the crosslinking agent with respect to the total amount of the cleaning agent composition may be 0.1 mass %˜5 mass %, may be 0.5 mass %˜4 mass %, or may be 1 mass % 3 mass %.

### (Curing Agent)

The cleaning agent composition may contain a curing agent, and may contain a curing agent, for example, in the case where epoxy resin is included as the main material. As the curing agent, there is no particular limitation as long as it may cure the epoxy resin, and for example, phenol compounds, amine-based compounds, imidazole-based compounds, acid anhydrides, and organic phosphoric acid compounds may be mentioned.

The curing agent may be used alone or in combination of two or more types.

As phenol compounds, for example, monocyclic bifunctional phenols such as hydroquinone, resorcinol, catechol; polycyclic bifunctional phenols such as bisphenol A, bisphenol F, naphthalene diols, biphenols; and multifunctional phenols such as halides thereof and alkyl group substituted derivatives may be mentioned.

As amine-based compounds, for example, N,N-benzyldimethylamine, 2-(dimethylaminomethyl)phenol, 2,4,6-tris(dimethylaminomethyl)phenol, tetramethylguanidine, triethanolamine, N,N′-dimethylpiperazine, 1,4-diazabicyclo[2.2.2]octane, 1,8-diazabicyclo[5.4.0]-7-undecene, 1,5-diazabicyclo[4.4.0]-5-nonene, hexamethylenetetramine, pyridine, picoline, piperidine, pyrrolidine, dimethylcyclohexylamine, dimethylhexylamine, cyclohexylamine, diisobutylamine, di-n-butylamine, diphenylamine, N-methylaniline, tri-n-propylamine, tri-n-octylamine, tri-n-butylamine, triphenylamine, tetramethylammonium chloride, tetramethylammonium bromide, tetramethylammonium iodide, triethylenetetramine, diaminodiphenylmethane, diaminodiphenyl ether, dicyandiamide, tolylbiguanide, guanylurea and dimethylurea may be mentioned.

As imidazole-based compounds, for example, imidazole, 2-ethylimidazole, 2-ethyl-4-methylimidazole, 2-methylimidazole, 2-phenylimidazole, 2-undecylimidazole, 1-benzyl-2-methylimidazole, 2-heptadecylimidazole, 4,5-diphenylimidazole, 2-methylimidazoline, 2-phenylimidazoline, 2-undecylimidazoline, 2-heptadecylimidazoline, 2-isopropylimidazole, 2,4-dimethylimidazole, 2-phenyl-4-methylimidazole, 2-ethylimidazoline, 2-phenyl-4-methylimidazoline, benzimidazole, 1-cyanoethylimidazole and 2,4-diamino-6-[2′-methylimidazolyl-(1′)]ethyl-s-triazine, etc. may be mentioned.

As acid anhydrides, for example, phthalic anhydride, hexahydrophthalic anhydride, pyromellitic dianhydride and benzophenone tetracarboxylic dianhydride may be mentioned.

As organic phosphorics compounds, for example, hexamethylphosphoric triamide, tri(dichloropropyl) phosphate, tri(chloropropyl) phosphate, triphenyl phosphite, trimethyl phosphate, phenylphosphonic acid, triphenylphosphine, tri-n-butylphosphine, diphenylphosphine organic phosphoric acid compounds and halides thereof may be mentioned.

In the case where the cleaning agent composition contains a crosslinking agent, the content rate of the crosslinking agent with respect to the total amount of the cleaning agent composition may be 0.1 mass %˜5 mass %, may be 0.5 mass %˜4 mass %, or may be 1 mass % 3 mass %.

### (Reinforcing Material)

The cleaning agent composition may contain a reinforcing material. As the reinforcing material, for example, inorganic fillers such as silica like amorphous silica, talc, alumina, calcium carbonate, and aluminum hydroxide may be mentioned.

The reinforcing material may be used alone as a single type or in combination of two or more types.

In the case where the cleaning agent composition contains a reinforcing material, the content rate of the reinforcing material with respect to the total amount of the cleaning agent composition may be 10 mass %˜50 mass %, may be 15 mass %˜40 mass %, or may be 20 mass %˜30 mass %.

The content of the reinforcing material with respect to 100 parts by mass of the main material may be 20 parts by mass˜55 parts by mass, may be 25 parts by mass˜50 parts by mass, or may be 30 parts by mass˜45 parts by mass.

By keeping the content of the reinforcing material at 55 parts by mass or less, an increase in the viscosity of the cleaning agent composition can be suppressed, and there is a tendency that the mold followability is excellent.

### (Mold Release Agent)

The cleaning agent composition may contain a mold release agent. As the mold release agent, fatty acid-based mold release agents, silicone oil, polyethylene, etc. may be mentioned.

The mold release agent may be used alone as a single type or in combination of two or more types.

As fatty acid-based mold release agents, aliphatic carboxylic acids, aliphatic carboxylic acid esters, fatty acid amides, etc. may be mentioned, and aliphatic carboxylic acids such as palmitic acid, stearic acid, caproic acid, capric acid, lauric acid, arachic acid, behenic acid, lignoceric acid, cerotic acid, melissic acid, tetratriacontanoic acid, montanic acid, adipic acid, azelaic acid; esters of these aliphatic carboxylic acids with alcohols having 30 or fewer carbon atoms; metal salts of these aliphatic carboxylic acids (for example, calcium salts and zinc salts); fatty acid amides such as oleic acid amide and stearic acid amide; carnauba wax, montan wax, etc. may be mentioned.

As silicone oils, dimethyl silicone oil, methyl phenyl silicone oil, methyl hydrogen silicone oil, etc. may be mentioned.

Among these, from the viewpoint of mode release properties, montanic acid ester and polyethylene are preferable as mold release agents.

In the case where the cleaning agent composition contains a mold release agent, the content rate of the mold release agent with respect to the total amount of the cleaning agent composition may be 1 mass %˜15 mass %, may be 2 mass %˜10 mass %, or may be 3 mass %˜5 mass %.

### (Other Components)

The cleaning agent composition may or may not contain other components besides the aforementioned components. As other components, cleaning agents, organic solvents, water, softeners such as aroma oils and naphthenic oils, vulcanizing agents such as sulfur, vulcanization accelerators, anti-aging agents, zinc oxide, etc. may be mentioned.

As cleaning agents, cleaning agents other than the aforementioned specific amine compounds may be mentioned. For example, alkali metal salts, alkali metal hydroxides such as potassium hydroxide, amide group-containing compounds such as propionamide, and primary amine compounds may be mentioned.

From the viewpoint of suppressing contamination of the outer periphery of the mold, the content rate of primary amines with respect to the total amount of the cleaning agent composition is preferably 1 mass % or less, more preferably 0.5 mass % or less, and even more preferably 0 mass %.

As organic solvents, for example, amide-based solvents, alcohol-based solvents, ketone-based solvents, ether-based solvents, hydrocarbon-based solvents, halogenated hydrocarbon-based solvents, phenol-based solvents, ester-based solvents, and sulfur-based solvents (such as dimethyl sulfoxide) may be mentioned.

From the viewpoint of maintaining cleaning power, organic solvents or water are sometimes used in the cleaning agent composition. However, the cleaning agent composition of the first embodiment contains a specific amine compound, and thus can maintain its cleaning power even without using an organic solvent or water. Furthermore, since no organic solvent and water are used, volatilization does not occur, and the cleaning agent composition of the first embodiment has excellent storage stability.

The cleaning agent composition may be manufactured by mechanically kneading each compound component using a Banbury mixer, kneader, roll mixer, extruder, etc.

### Second Embodiment

A cleaning agent composition according to the second embodiment of the disclosure includes a reinforcing material of the cleaning agent composition, and an amine compound (specific amine compound) which does not include an amino group located at an end of a molecular chain but includes an amino group located at a position other than the end of the molecular chain. The cleaning agent composition of the second embodiment differs from the first embodiment in that the reinforcing material is an essential component instead of the main material. By the cleaning agent composition of the second embodiment including the specific amine compound, contamination of the outer periphery of the mold can be suppressed even in the case of repeatedly cleaning the mold using the cleaning agent composition.

The description of preferred configurations common to the first embodiment is omitted.

As the reinforcing material used in the second embodiment, similar to the first embodiment, inorganic fillers such as silica (e.g., amorphous silica), talc, alumina, calcium carbonate, and aluminum hydroxide may be mentioned.

The content rate of the reinforcing material with respect to the total amount of the cleaning agent composition may be 40 mass %˜95 mass %, may be 50 mass %˜90 mass %, or 50 may be mass %˜70 mass %.

The cleaning agent composition of the second embodiment may contain other components besides the reinforcing material and the specific amine compound. For example, materials exemplified as the aforementioned main materials, crosslinking agents, curing agents, mold release agents, and other components may be mentioned.

### Third Embodiment

A cleaning agent composition according to the third embodiment of the disclosure contains an amine compound (specific amine compound) which does not include an amino group located at an end of a molecular chain but includes an amino group located at a position other than the end of the molecular chain, and is used for cleaning a mold for molding of thermosetting resin. The cleaning agent composition of the third embodiment differs from the first embodiment and the second embodiment in that the main material and the reinforcing material are not essential components and in that it is used exclusively for cleaning a mold for molding of thermosetting resin. By the cleaning agent composition of the third embodiment containing a specific amine compound, even in the case of repeatedly cleaning the mold using the cleaning agent composition, contamination of the outer periphery of the mold can be suppressed.

The description of preferred configurations common to the first embodiment and the second embodiment will be omitted.

The cleaning agent composition of the third embodiment may be used without being combined with a main material or a reinforcing material as long as it is used for cleaning a mold for molding of thermosetting resin.

### [Cleaning Material]

The cleaning material of the disclosure is a cleaning material formed by molding any one of the cleaning agent compositions according to the first embodiment to the third embodiment of the disclosure as described above.

The cleaning material of the disclosure is, for example, a part formed by molding the aforementioned cleaning agent composition into a powder, tablet, sheet, small piece, film, or strip shape. The cleaning material of the disclosure may be a laminate of the cleaning agent composition molded into film or sheet shapes, or it may be a laminate or adhesion of the cleaning agent composition molded into film or sheet shapes with parts of different characteristics in film or sheet shapes. The cleaning material is used, for example, to clean a mold. When the cleaning material is a sheet-like part, the thickness of the cleaning agent may be 3 mm˜10 mm.

### [Method of Cleaning Mold for Molding]

The method of cleaning mold for molding of the disclosure is a method that includes: a step of placing the cleaning material of the disclosure inside the opened mold for molding; a step of sandwiching the cleaning material using the mold for molding by closing the mold for molding and applying heat and pressure; and a step of peeling off the cleaning material from the mold for molding.

The method of cleaning mold for molding includes a step of placing the cleaning material of the disclosure inside the opened mold for molding. For example, the cleaning material molded into powder, tablet, sheet, or strip shape is placed inside the opened mold for molding. As an example, a sheet-shaped cleaning material may be placed between the upper mold and lower mold, each of which has a concave part formed in the mold.

The method of cleaning mold for molding includes a step of sandwiching the cleaning material using the mold for molding by closing the mold for molding and applying heat and pressure. With the cleaning material placed inside the opened mold for molding, the cleaning material is sandwiched using the mold for molding by closing the mold for molding and heat and pressure are applied. By applying pressure, the cleaning material placed inside the mold for molding is filled into the cavity composed of the concave part of the upper mold and the concave part of the lower mold, and is pressed against the mold surface. Moreover, by applying heat, the contaminants adhering to the inside of the mold are integrated with the cleaning material. In this case, depending on the situation, burrs formed around the cavity may also be integrated.

The method of cleaning mold for molding includes a step of peeling off the cleaning material from the mold for molding. For example, after applying heat and pressure for a predetermined time as described above, the upper mold and lower mold are opened, and the cleaning material is peeled off from both the upper and lower molds. In this manner, the cleaning of the mold is performed.

The conditions for sandwiching the cleaning material using the mold, compression molding, and heating are appropriately set according to the composition and type of the cleaning material. For example, in the case of using rubber material or resin material as the main material, it is preferable to heat under conditions of 160° C.˜190° C. for 1˜5 minutes.

As the mold to be cleaned using the method of cleaning mold for molding of the disclosure, for example, a mold for molding for thermosetting resin may be mentioned. More specifically, the mold to be cleaned may be a mold for molding for semiconductor device encapsulation in which molding is repeatedly performed using thermosetting resin.

As the thermosetting resin, for example, epoxy resin may be mentioned. The mold to be cleaned may be a mold for molding for semiconductor device encapsulation in which molding is repeatedly performed using a resin composition containing epoxy resin.

The resin composition may contain, along with the epoxy resin, a curing agent, and additionally, if necessary, additives such as inorganic filler and curing accelerator.

The mold for molding cleaned by the method of cleaning of the disclosure has had contaminants removed and has returned to the initial state of the mold surface. Therefore, when performing molding using thermosetting resin, it is preferable to apply a mold release agent to the mold surface in advance. For example, in the case of molding a molding material containing montanic acid wax as a mold release agent, it is preferable to apply the same montanic acid wax, and in the case of molding a molding material containing carnauba wax, it is preferable to apply the same carnauba wax. Also, as the method of applying the mold release agent to the mold surface, it is preferable to prepare an unvulcanized rubber composition containing the mold release agent and form it into a sheet. For example, a sheet obtained by compounding a mold release agent with the unvulcanized rubber described in Japanese Patent Application Laid-Open Publication No. 2011-020416 may be mentioned. Then, by loading this sheet formed of the unvulcanized rubber composition containing the mold release agent into the mold and heating it, the contained mold release agent is applied to the mold surface. This is thought to be because during heat vulcanization, the mold release agent in the unvulcanized rubber composition melts and seeps onto the mold surface, forming a uniform mold release agent film on the surface.

### EXAMPLES

The embodiments of the disclosure will now be specifically described by Examples, but the embodiments of the disclosure are not limited to these Examples.

First, each component constituting the cleaning agent composition was prepared.
1) EPR (main material): Ethylene-propylene-diene rubber, manufactured by Mitsui Chemicals, Inc., EPT4045 (ethylene content: 54 mol %, diene component content: 8.1 mol %)
2) BR (main material): Butadiene rubber, manufactured by JSR Corporation, BR-01 (cis-1,4 bond: 95%)
3) Amorphous silica particles (reinforcing material): BET specific surface area 200 m²/g, bulk specific gravity 140 g/L
4) Titanium oxide: average particle diameter 0.25 μm
5) Amide-based wax: mold release agent
6) Organic peroxide: crosslinking agent
7) AEE: 2-(2-aminoethoxy)ethanol, boiling point 222° C., primary amine compound
8) NMEOA: Methylethanolamine, boiling point 159° C., secondary amine compound
9) BEOA: Butylethanolamine, boiling point 198° C., secondary amine compound
10) DIPOA: Diisopropanolamine, boiling point 249° C., secondary amine compound
11) DEOA: Diethanolamine, boiling point 269° C., secondary amine compound
12) ODEOA: Octyldiethanolamine, boiling point 319° C., tertiary amine compound
13) 2-Amino-2-methyl-1-propanol, boiling point 165° C., primary amine compound

### Examples 1˜8 and Comparative Examples 1, 2

The components constituting the cleaning agent composition were compounded in the ratios shown in Table 1, and this was kneaded using a kneading roll, and then formed into a sheet-like shape (5 mm thickness) using a rolling roll to produce the desired sheet-like cleaning material.

The units of the numerical values for each component in Table 1 and Table 2 are parts by mass, and blank spaces in Table 1 and Table 2 indicate that the component was not compounded.

TABLE 1

| | Comparative | | |
|---|---|---|---|
| | Example 1 | Example 1 | Example 2 |
| EPR | 50 | 50 | 50 |
| BR | 50 | 50 | 50 |
| Amorphous Silica Particles | 40 | 40 | 40 |
| Titanium oxide | 4 | 4 | 4 |
| Amide-based wax | 2 | 2 | 2 |
| Organic peroxide | 2 | 2 | 2 |
| AEE | 8 | | |
| NMEOA | | 8 | |
| BEOA | | | 8 |
| Total | 156 | 156 | 156 |

TABLE 2

| | | | | | | | Comparative |
|---|---|---|---|---|---|---|---|
| | Example 3 | Example 4 | Example 5 | Example 6 | Example 7 | Example 8 | Example 2 |
| EPR | 50 | 50 | 50 | 50 | 50 | 50 | 50 |
| BR | 50 | 50 | 50 | 50 | 50 | 50 | 50 |
| Amorphous Silica Particles | 40 | 40 | 40 | 40 | 40 | 40 | 40 |
| Titanium oxide | 4 | 4 | 4 | 4 | 4 | 4 | 4 |
| Amide-based wax | 2 | 2 | 2 | 2 | 2 | 2 | 2 |
| Organic peroxide | 2 | 2 | 2 | 2 | 2 | 2 | 2 |
| DIPOA | 8 | | | | | | |
| DEOA | | 8 | | | | | |
| ODEOA | | | 8 | | | | |
| NMEOA | | | | 15 | 20 | 25 | |
| 2-Amino-2-methyl-1-propanol | | | | | | | 8 |
| Total | 156 | 156 | 156 | 163 | 168 | 173 | 156 |

### [Contamination Evaluation 1 of the Outer Periphery of the Mold for Molding]

Using each of the cleaning materials of Examples 1 and 2 and Comparative Example 1 obtained as described above, the contamination of the outer periphery of the mold for molding was evaluated as follows. 1.0 g of each cleaning material was sandwiched between the upper and lower molds at 175° C., and removed from the upper and lower molds after heat curing for 5 minutes. This process was repeated 50 times. Subsequently, it was evaluated whether contaminants were adhered to the outer peripheral part of the upper and lower mold surfaces.

In this evaluation, gas contamination significantly occurred in Comparative Example 1 using AEE, while in Examples 1 and 2, the occurrence of gas contamination was suppressed.

### [Cleaning Evaluation 1 of Cleaning Material]

An iron plate was prepared by coating with an epoxy resin molding material, which is a semiconductor encapsulation resin, at high temperature and curing it at 175° C. for 24 hours to surface-treat it. Next, the cleaning materials of Examples 1, 2 and Comparative Example 1 obtained as described above were placed on the surface-treated iron plate, and each cleaning material was heated and pressurized under conditions of 175° C. for 5 minutes. Subsequently, each cleaning material was peeled off from the iron plate, and the degree of removal of the epoxy resin molding material (i.e., the cleaning effect of the cleaning material) was evaluated. In any one of Examples 1, 2 and Comparative Example 1, excellent removal of the epoxy resin molding material was observed, confirming the cleaning effect of the cleaning materials.

As the epoxy resin molding material, a material containing epoxy resin, a phenol compound as a curing agent, and silica particles as an inorganic filler was used, with an equivalent ratio of epoxy groups to phenolic hydroxyl groups of 1:1, and a content rate of inorganic filler of 78 volume % was used.

### [Contamination Evaluation 2 of the Outer Periphery of the Mold for Molding]

Using the cleaning materials obtained from each Example and Comparative Example as described above, the same procedure as [Contamination evaluation 1 of the outer periphery of the mold for molding] was performed. Then, whether contaminants were adhered to the outer peripheral parts of the upper and lower mold surfaces was evaluated according to the following evaluation criteria. The results are shown in Table 3.

### (Evaluation Criteria)

A: The occurrence of gas contamination was suppressed.
B: Gas contamination occurred but was within an acceptable range.
C: Gas contamination occurred significantly.

### [Cleaning Evaluation 2 of Cleaning Material]

Using the cleaning materials obtained from each Example and Comparative Example as described above, the same procedure as [Cleaning evaluation 1 of cleaning material] was performed. Then, the degree of removal of the epoxy resin molding material (i.e., the cleaning effect of the cleaning material) was evaluated according to the following evaluation criteria. The results are shown in Table 3.

### (Evaluation Criteria)

A: When each cleaning material was peeled off from the iron plate, the epoxy resin molding material was sufficiently removed.
B: When each cleaning material was peeled off from the iron plate, some of the epoxy resin molding material remained on the iron plate without being removed.
C: When each cleaning material was peeled off from the iron plate, a large amount of the epoxy resin molding material remained on the iron plate without being removed.

### [Blooming Property]

Using the cleaning materials obtained from each Example and Comparative Example as described above, they were stored at 20° C. for 24 hours and then visually inspected. Then, the blooming property was evaluated according to the following evaluation criteria. The results are shown in Table 3.

### (Evaluation Criteria)

A: No seeping of the cleaning material.
B: Seeping of the cleaning material observed.

TABLE 3

| | Comparative | Example | Example | Example | Example | Example | Example | Example | Example | Comparative |
|---|---|---|---|---|---|---|---|---|---|---|
| | Example 1 | 1 | 2 | 3 | 4 | 5 | 6 | 7 | 8 | Example 2 |
| Contamination | C | A | A | B | B | A | A | A | B | C |
| evaluation | | | | | | | | | | |
| Cleaning | B | A | A | A | A | A | A | A | A | A |
| evaluation | | | | | | | | | | |
| Blooming | A | A | A | A | A | A | A | B | B | A |

In each of the Examples, the occurrence of gas contamination was suppressed in comparison to Comparative Examples 1 and 2.

In the Examples, the use of secondary amine compounds resulted in favorable evaluations of cleaning performance.

Furthermore, in the Examples, it was confirmed that by setting the amount of the amine compound to 15 parts by mass or less with respect to 100 parts by mass of the total of EPR and BR as the main materials, excellent blooming property were achieved.

The disclosure of PCT/JP2023/027450, filed on Jul. 26, 2023, is incorporated in its entirety into this specification by reference.

All literature, patent applications, and technical standards described in this specification are incorporated by reference into this specification to the same extent as if each individual literature, patent application, and technical standard was specifically and individually indicated to be incorporated by reference.

1. A cleaning agent composition, comprising:
a main material of the cleaning agent composition; and
an amine compound which does not include an amino group located at an end of a molecular chain but includes an amino group located at a position other than the end of the molecular chain.

2. A cleaning agent composition, comprising:
a reinforcing material of the cleaning agent composition; and
an amine compound which does not include an amino group located at an end of a molecular chain but includes an amino group located at a position other than the end of the molecular chain.

3. A cleaning agent composition, comprising an amine compound which does not include an amino group located at an end of a molecular chain but includes an amino group located at a position other than the end of the molecular chain and used for cleaning a mold for molding of thermosetting resin.

4. The cleaning agent composition according to claim 1, wherein the amine compound contains at least one compound selected from a group consisting of a secondary amine compound and a tertiary amine compound.

5. The cleaning agent composition according to claim 4, wherein the amine compound contains the secondary amine compound, and
the secondary amine compound is at least one selected from a group consisting of methylethanolamine, ethylethanolamine, propylethanolamine, butylethanolamine, dimethylamine, diisopropanolamine, and diethanolamine.

6. The cleaning agent composition according to claim 1, wherein the amine compound contains only one hydroxyl group.

7. The cleaning agent composition according to claim 1, wherein a content of the amine compound with respect to 100 parts by mass of the main material is less than 20 parts by mass.

8. A cleaning material formed by molding the cleaning agent composition according to claim 1.

9. A method of cleaning mold for molding, comprising:
a step of placing the cleaning material according to claim 8 inside an opened mold for molding;
a step of sandwiching the cleaning material using the mold for molding by closing the mold for molding, and applying heat and pressure; and
a step of peeling off the cleaning material from the mold for molding.

10. The cleaning agent composition according to claim 2, wherein the amine compound contains at least one compound selected from a group consisting of a secondary amine compound and a tertiary amine compound.

11. The cleaning agent composition according to claim 3, wherein the amine compound contains at least one compound selected from a group consisting of a secondary amine compound and a tertiary amine compound.

12. The cleaning agent composition according to claim 2, wherein the amine compound contains only one hydroxyl group.

13. The cleaning agent composition according to claim 3, wherein the amine compound contains only one hydroxyl group.

14. The cleaning agent composition according to claim 2, wherein a content of the amine compound with respect to 100 parts by mass of the main material is less than 20 parts by mass.

15. The cleaning agent composition according to claim 3, wherein a content of the amine compound with respect to 100 parts by mass of the main material is less than 20 parts by mass.

16. A cleaning material formed by molding the cleaning agent composition according to claim 2.

17. A cleaning material formed by molding the cleaning agent composition according to claim 3.

18. A cleaning material formed by molding the cleaning agent composition according to claim 4.

19. A cleaning material formed by molding the cleaning agent composition according to claim 5.

20. A cleaning material formed by molding the cleaning agent composition according to claim 6.
